(19) United States
(12) Patent Application Publication
(10) Pub. No.: US 2026/0341601 A1
(43) Pub. Date: Oct. 29, 2026

(54) FORMATION ELECTROLYTE FOR TANTALUM SOLID ELECTROLYTE CAPACITORS

(71) Applicant: KEMET Electronics Corporation, Fort Lauderdale, FL (US)

(72) Inventors: Subarna BANERJEE, Simpsonville, SC (US); Ajaykumar BUNHA, Simpsonville, SC (US); John T. KINARD, Simpsonville, SC (US); Antony P. CHACKO, Simpsonville, SC (US)

(21) Appl. No.: 19/723,207

(22) Filed: Jun. 29, 2026

Related U.S. Application Data
(62) Division of application No. 18/126,785, filed on Mar. 27, 2023.

(51) Int. Cl. H01G 9/025; C07F 9/117; H01G 9/00; H01G 9/04; H01G 9/042; H01G 9/052; H01G 9/07; H01G 9/15

(52) U.S. Cl. CPC H01G 9/025; C07F 9/117; H01G 9/0032; H01G 9/042; H01G 9/052; H01G 9/15; H01G 2009/05; H01G 9/07

(57) ABSTRACT

An improved formation electrolyte suitable for formation of an oxide on a valve metal anode and an improved capacitor comprising an oxide formed in the formation electrolyte is provided. The formation electrolyte comprises a derivative of inositol is defined by Formula 1:

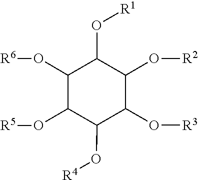

wherein:
each of R¹-R⁶ is defined.

### CROSS-REFERENCE TO RELATED APPLICATION

This application is a divisional of and hereby claims priority under U.S.C. § 120 to co-pending U.S. patent application Ser. No. 18/126,785, filed on Mar. 27, 2023, the entire contents of which are incorporated herein by reference.

### FIELD OF THE INVENTION

The present invention is related to an improved formation (anodization), electrolyte for the formation of tantalum oxide dielectric on a tantalum anode body. More specifically, the present invention is specific to a formation electrolyte comprising compounds derived from inositol which significantly improves oxide formation.

### BACKGROUND

Solid electrolytic capacitors comprising oxide formed on sintered tantalum as the anode and conductive polymer as the cathode are now utilized extensively throughout the electronics industry in virtually every application necessitating a capacitive couple in the electronic assembly. As would be fully understood by those of skill in the art, tantalum oxide is formed on the tantalum surface wherein the tantalum oxide functions as the dielectric between the tantalum anode and conductive polymer cathode. The process of forming tantalum oxide by subjecting the anode to voltage in the presence of an electrolyte is referred to as anodization.

Dielectric quality is a measure of electrical property of a solid electrolytic capacitor. Poor dielectric may cause failure of the part. One factor that contributes to faulty electrical properties is anomalous charge current (ACC). Parts formed in currently available anodization electrolytes exhibit high ACC wherein the high ACC is now known to be detrimental to electrolytic capacitor quality. This has led to a significant effort to develop an improved forming, or anodizing electrolyte which provides a more stable dielectric resulting in an improved solid electrolytic capacitor, particularly with a lower ACC.

Solid electrolytic capacitors using valve metal as anodes, specifically tantalum, and conductive polymer as cathode, display anomalous charge current (ACC) which exceeds the theoretical value {I(t)) calculated as: I(t)=C*dv/dt with C being the capacitance and dV/dt being the voltage ramp}. ACC might interfere with circuit performance thereby leading to faulty capacitors as described in Y. Freeman and P. Lessner Evolution of Polymer Tantalum Capacitors Appl. Sci. 2021, 11(12), 5514-5521.

Provided herein is an improved electrolyte which is particularly suitable for use in the formation of tantalum oxide on tantalum wherein the tantalum oxide functions as an improved dielectric in a solid electrolytic capacitor.

### SUMMARY OF THE INVENTION

The present invention is related to an improved formation electrolyte which is particularly suitable for use in the formation of tantalum oxide on tantalum.

More specifically, the present invention is related to a capacitor with improved electrical properties, comprising a tantalum anode and conductive polymer cathode with an improved tantalum oxide dielectric there between.

A particular feature of the present invention is the ability to form a dielectric oxide on a tantalum anode without alteration of the manufacturing steps, equipment or procedures.

These and other advantages, as will be realized, are provided in a formation electrolyte suitable for formation of an oxide on a valve metal anode comprising a derivative of inositol is defined by Formula 1:

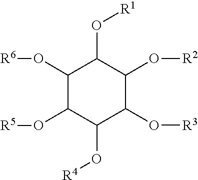

wherein:
each of R¹-R⁶ is independently selected from H, substituted or unsubstituted carbon chain of up to 20 carbon atoms, —PO₃R⁷R⁸; —SiR⁹₃, —C(O)R¹⁰; and

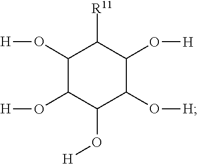

or adjacent groups may be taken together to represent —P(O)OH—O—P(O)OH—;
each R⁷ and R⁸ are independently selected from H, a cation; saturated or unsaturated carbon chain of up 35 carbon atoms; or —CH₂CHR¹²CH₂R¹³
each R⁹ is independently an alkyl of 1 to 10 carbon atoms;
each R¹⁰ is independently an alkyl of 1 to 10 carbon atoms;
each R¹¹ represents a bond to an oxygen of the derivative of inositol of Formula 1; and
R¹² and R¹³ are esters terminated with H, saturated or unsaturated carbon chain of 1 to 35 carbon atoms

Yet another embodiment is provided in a method of forming a solid electrolytic capacitor comprising:
forming a dielectric oxide on a tantalum anode by:
applying a formation electrolyte on said anode wherein said formation electrolyte comprises a derivative of inositol is defined by Formula 1:

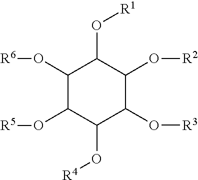

wherein:
each of R¹-R⁶ is independently selected from H, substituted or unsubstituted carbon chain of up to 20 carbon atoms, —PO₃R⁷R⁸; —SiR⁹₃, —C(O)R¹⁰; and

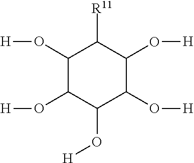

or adjacent groups may be taken together to represent —P(O)OH—O—P(O)OH—; each R⁷ and R⁸ are independently selected from H, a cation; saturated or unsaturated carbon chain of up 35 carbon atoms; or —CH₂CHR¹²CH₂R¹³;
each R⁹ is independently an alkyl of 1 to 10 carbon atoms;
each R¹⁰ is independently an alkyl of 1 to 10 carbon atoms;
each R¹¹ represents a bond to an oxygen of the derivative of inositol of Formula 1; and
R¹² and R¹³ are esters terminated with H, saturated or unsaturated carbon chain of 1 to 35 carbon atoms; and
forming a conductive polymer cathode on said dielectric oxide.

### DESCRIPTION

The present invention is related to improved solid electrolytic capacitor comprising an improved tantalum oxide dielectric wherein the properties of the solid electrolytic capacitor, and particularly ACC, are significantly improved relative to the art. More specifically, the present invention is related to an improved formation electrolyte suitable for use in the formation of an improved tantalum oxide on a tantalum anode that yields low wet leakage. The capacitor formed with the improved tantalum oxide provides an improved solid electrolytic capacitor, particularly, when used with solid conductive polymer cathodes.

High ACC in solid electrolytic capacitors is solved by formation of tantalum oxide on a tantalum anode in an electrolyte that comprises derivatives of inositol. Without being limited to theory, it is hypothesized that the derivatives of inositol are capable of bonding with the free hydroxyl groups present on the surface of tantalum or with tantalum oxide thereby stabilizing the interface of the growing dielectric and anode which facilitates improved tantalum oxide growth.

The present invention is related to improved electrical properties in solid electrolytic capacitors and more specifically anomalous charge current (ACC). This invention provides a method of forming a dielectric oxide film on a tantalum anode and of making a solid electrolytic capacitor therewith. Formation in the inventive forming electrolyte, having free terminal O⁻ ion upon ionization, in aqueous solution, forms an improved dielectric oxide layer. Without being limited to theory, it is hypothesized that the geometry of the ions of the inventive forming electrolyte anchor to the tantalum surface, which has free hydroxyl groups. The bonding/anchoring of the ions, facilitates more electrolyte molecule access and in effect forms uniform oxide. Another hypothesis is that a portion of the inventive forming electrolyte remains on the surface of the tantalum oxide and forms a stable interface between dielectric and conductive polymer at the p-n junction. This assists in possible tunneling and significantly reduces anomalous charge current (ACC) in solid electrolytic capacitors.

Forming a stable dielectric interface is crucial for having stable electrical properties. The dielectric is formed by anodically oxidizing the metal anode in the electrolyte that contains the inventive forming electrolyte. Through selective control over a voltage range, the anodization process leads to a dielectric having better electrical properties which in turn leads to a capacitor having improved ACC exhibiting less anomalous charge current when charged at a constant voltage slew rate such as 100 volts/second.

The derivative of inositol is defined by Formula 1

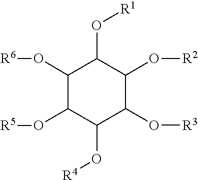

wherein:
each of R¹-R⁶ is independently selected from H, substituted or unsubstituted carbon chain of up to 20 carbon atoms, —PO₃R⁷R⁸, —SiR⁹₃, C(O)R¹⁰; and

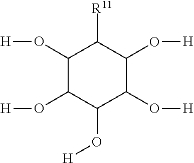

or adjacent groups may be taken together to represent —P(O)OH—O—P(O)OH—; each R⁷ and R⁸ are independently selected from H, a cation; saturated or unsaturated carbon chain of up 35 carbon atoms; or —CH₂CHR¹²CH₂R¹³ each R⁹ is independently an alkyl of 1 to 10 carbon atoms and preferably 1 to 3 carbon atoms with —CH₃ being particularly preferred;
each R¹⁰ is independently an alkyl of 1 to 10 carbon atoms and preferably 1 to 3 carbon atoms with —CH₃ being particularly preferred;
Each R¹¹ represents a bond to an oxygen of the derivative of inositol of Formula 1; and R¹² and R¹³ are esters terminated with H, saturated or unsaturated carbon chain of 1 to 35 carbon atoms.

In a preferred embodiment at least one of R¹-R⁶ is PO₃R⁷R⁸ with at least one of R⁷ or R⁸ being H and preferably R⁷ and R⁸ are both H. In a more preferred embodiment at least two of R¹-R⁶ is —PO₃R⁷R⁸ with at least one of R⁷ or R⁸ being H and preferably R⁷ or R⁸ are both —H. In a more preferred embodiment at least three of R¹R⁶ is PO₃R⁷R⁸ with at least one of R⁷ or R⁸ being H and preferably R⁷ and R⁸ are both H. In a more preferred embodiment at least four of R¹-R⁶ is PO₃R⁷R⁸ with at least one of R⁷ or R⁸ being —H and preferably R⁷ and R⁸ are both H. In a more preferred embodiment at least five of R¹-R⁶ is PO₃R⁷R⁸ with at least one of R⁷ or R⁸ being H and preferably R⁷ and R⁸ are both H. In a more preferred embodiment each of R¹-R⁶ is PO₃R⁷R⁸ with at least one of R⁷ or R⁸ being —H and preferably R⁷ and R⁸ are both H.

R⁷ and R⁸ can be a cation preferably selected from quaternary amines, ammonium; metal cation, saturated or unsaturated carbon chain of up 35 carbon atoms, preferably 10-17 carbon atoms.

Substituted or unsubstituted carbon chains include alkyl chains and alkene chains which are straight chains, branched chains or cyclic which may be substituted or unsubstituted. Substitutions include ethers, —OH, carboxylic acids, phosphonic acids, phosphinic acids, esters, amines and amides.

Particularly preferred derivatives of inositol are selected from the group consisting of myo-inositol and it's isomers and their respective derivatives namely myo-inositol hexakis-phosphate (phytic acid); pentakis-, tri-, di-phosphates and their isomers; and myo-inositol mono phosphate, myo-inositol trispyrophosphate, 1-phosphatidyl-myo-inositol, 1-phosphatidyl-myo-inositol 3-phosphate, derivatives of ononitol, sequoytol, dombonitol, viscumitol, pinitol, quebrachitol, pinpollitol and brahol, myo-inositol 1,3,4,5,6-pentakis-O-(trimethylsilyl)-, bis(trimethylsilyl) phosphate, phosphatidylinositol 5-phosphate PI(5) diC8 ammonium salt, phosphatidylinositol 5-phosphate diC16 (PI(5)P diC16) sodium salt, 1,2-ciacyl-sn-glycero-3-phospho-(1-D-myo-inositol 4,5-biphosphate), phosphatidylinositol, phosphatidylinositol 3-phosphate, phosphatidylinositol 4-phosphate, phosphatidylinositol 4,5-phosphate, di-myo-inositol-phosphate, ciceritol phosphate, fagopyritol phosphate, glycosylinositol phosphryl ceramide, C25,25-Archeditylinositol, ceramide phosphoinositol, D-myo-inositol-4-hydrogen phosphate monoammonium salt and phosphatidylinositol phosphate.

The formation electrolyte may further comprise additives selected from metal salts, salts of organic acids, salts of inorganic acids, organic acids, inorganic acids, organornetallic compounds, inorganic solvents, organic solvents, crosslinking agents, surface active agents, buffers and the like.

The metal salts, salts of inorganic acids and salts of organic acids included in the formation electrolyte may comprise halides, nitrides, sulfides, amides, nitrates, sulfates, phosphates, carbonates, chromates, chlorates, perchlorates, oxides, oxychlorides, peroxides, carboxylates, amides and esters.

The organic and inorganic acids included in the formation electrolyte may comprise carboxylic acids, phosphonic acids, phosphinic acids, pyrophosphoric acids, phosphoric acid, phthalic acid, maleic acid, malonic acid and trimesic acid and the like.

The organometallic compounds included in the formation electrolyte may comprise organosilanes, organoboranes, carbonyls, phosphines, crosslinking agents, surface active agents and buffers.

The solvent included in the formation electrolyte may be selected from the group consisting of water, alcohol, ethylene glycol, polyethylene glycol, tetraglyme, propylene glycol, glycol ether and alkanolamines.

The solid electrolytic capacitor comprises an anode, a cathode and a dielectric oxide between the anode and cathode. The anode is a sintered porous tantalum metal which is anodized to form the dielectric oxide. The dielectric oxide layer is covered by solid electrolyte, which is preferably a conductive polymer, which acts as cathode. The dielectric oxide is formed by subjecting the anode to voltage, in the presence of an inventive forming electrolyte in a process referred to in the art as anodization.

The solid electrolytic capacitor comprises an anode, a cathode and a dielectric oxide between the anode and cathode. The anode is a sintered porous tantalum metal which is anodized to form the dielectric oxide. The dielectric oxide layer is covered by solid electrolyte, which is preferably a conductive polymer, which acts as cathode. The dielectric oxide is formed by subjecting the anode to voltage, in the presence of an inventive forming electrolyte in a process referred to in the art as anodization.

After formation (anodization) of the anode, with a dielectric thereon can be washed. In one embodiment the anode, with a dielectric thereon is not washed which allows residual formation electrolyte to remain anchored to the surface which facilitates bonding with the cathode layer.

Formation temperatures of about 60-125° C. are suitable for demonstration of the invention. More preferably an anodization temperature of about 75-90° C. is suitable for demonstration of the invention.

The anomalous charging current (ACC) refers to the ideal current (I ideal) in milliamps (mA) for charging a capacitor I_{ideal}=1000*C(dv/dt), C is the capacitance in Farads and dv/dt is the instantaneous rate of voltage change which is typically about 100V/S. Thus, the actual charging current remains the same or is greater than the ideal charging current (I_{ideal}). I_{actual}/I_{ideal}=1 or greater than 1.

The structure of a solid electrolytic capacitor is well understood by those of skill in the art and further elaboration is not necessary herein.

The conductive polymer is preferably selected from a group consisting of polyanilines, polypyrroles and polythiophenes each of which may be substituted. A particularly preferred polymer comprises conjugated groups having the structure of Formula 2:

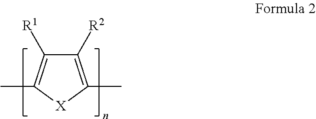

wherein:
R¹ and R² independently represent linear or branched C₁C₁₆ alkyl or C₂C₁₈ alkoxyalkyl; or are C₃-C₈ cycloalkyl, phenyl or benzyl which are unsubstituted or substituted by C₁C₆ alkyl, C₁-C₆ alkoxy, halogen or OR³; or R¹ and R², taken together, are linear C₁-C₆ alkylene which is unsubstituted or substituted by C₁-C₆ alkyl, C₁-C₆ alkoxy, halogen, C₃-C₈ cycloalkyl, phenyl, benzyl, C₁-C₄ alkylphenyl, C₁-C₄ alkoxyphenyl, halophenyl, C₁-C₄ alkylbenzyl, C₁-C₄ alkoxybenzyl or halobenzyl, 5-, 6-, or 7-membered heterocyclic structure containing two oxygen elements. R³ preferably represents hydrogen, linear or branched C₁-C₁₆ alkyl or C₂-C₁₈ alkoxyalkyl; or are C₃-C₈ cycloalkyl, phenyl or benzyl which are unsubstituted or substituted by C₁-C₆ alkyl;
X is S, N or O and most preferable X is S;
R¹ and R² of Formula 2 are preferably chosen to prohibit polymerization at the β-site of the ring as it is most preferred that only α-site polymerization be allowed to proceed; it is more preferred that R¹ and R² are not hydrogen and more preferably, R¹ and R² are α-directors with ether linkages being preferable over alkyl linkages; it is most preferred that the R¹ and R² are small to avoid steric interferences.

In a particularly preferred embodiment the R¹ and R² of Formula 1 are taken together to represent —O—(CHR⁴)ₙ—O— wherein:
n is an integer from 1 to 5 and most preferably 2;
R⁴ is independently selected from hydrogen; a linear or branched C₁ to C₁₈ alkyl radical C₅ to C₁₂ cycloalkyl radical, C₆ to C₁₄ aryl radical C₇ to C₁₈ aralkyl radical or C₁ to C₄ hydroxyalkyl radical, optionally substituted with a functional group selected from carboxylic acid, hydroxyl, amine, substituted amines, alkene, acrylate, thiol, alkyne, azide, sulfate, sulfonate, sulfonic acid, imide, amide, epoxy, anhydride, silane, and phosphate; hydroxyl radical; or R⁴ is selected from —(CHR⁵)ₐ—R¹⁶; —O(CHR⁵)ₐR¹⁶; —CH₂O(CHR⁵)ₐR¹⁶; —CH₂O(CH₂CHR⁵O)ₐR¹⁶, or
R⁴ is a functional group selected from the group consisting of hydroxyl, carboxyl, amine, epoxy, amide, imide, anhydride, hydroxymethyl, alkene, thiol, alkyne, azide, sulfonic acid, benzene sulfonic sulfonate, SO₃M, anhydride, silane, acrylate and phosphate;
R⁵ is H or alkyl chain of 1 to 5 carbon atoms optionally substituted with a functional group selected from carboxylic acid, hydroxyl, amine, alkene, thiol, alkyne, azide, epoxy, acrylate and anhydride;
R¹⁶ is H or SO₃M or an alkyl chain of 1 to 5 carbon atoms optionally substituted with a functional group selected from carboxylic acid, hydroxyl, amine, substituted amines, alkene, thiol, alkyne, azide, amide, imide, sulfate, SO₃M, amide, epoxy, anhydride, silane, acrylate and phosphate;
a is integer from 0 to 10; and
M is a H or cation preferably selected from ammonia, sodium or potassium.

The conducting polymer can be either a water-soluble or water-dispersible compound. Examples of such a π conjugated conductive polymer include polypyrrole or polythiophene. Particularly preferred conductive polymers include poly(3,4-ethylenedioxythiophene), poly(4-(2,3-dihydrothieno-[3,4-b][1,4]dioxin-2-yl)methoxy)-1-butane-sulphonic acid, salt), poly(4-(2,3-dihydrothieno-[3,4-b][1,4]dioxin-2-yl)methoxy)-1-propane-sulphonic acid, salt), poly(4-(2,3-dihydrothieno-[3,4-b][1,4]dioxin-2-yl)methoxy)-1-methyl-1-propane-sulphonic acid, salt), poly(4-(2,3-dihydrothieno-[3,4-b][1,4]dioxin-2-yl)methoxy alcohol, poly(N-methylpyrrole), poly(3-methylpyrrole), poly(3-octylpyrrole), poly(3-decylpyrrole), poly(3-dodecylpyrrole), poly(3,4-dimethylpyrrole), poly(3,4-dibutylpyrrole), poly(3-carboxypyrrole), poly(3-methyl-4-carboxypyrrole), poly(3-methyl-4-carboxyethylpyrrole), poly(3-methyl-4-carboxybutylpyrrole), poly(3-hydroxypyrrole), poly(3-methoxypyrrole), polythiophene, poly(3-methylthiophene), poly(3-hexylthiophene), poly(3-heptylthiophene), poly(3-octylthiophene), poly(3-decylthiophene), poly(3-dodecylthiophene), poly(3-octadecylthiophene), poly(3-bromothiophene), poly(3,4-dimethylthiophene), poly(3,4-dibutylthiophene), poly(3-hydroxythiophene), poly(3-methoxythiophene), poly(3-ethoxythiophene), poly(3-butoxythiophene), poly(3-hexyloxythiophene), poly(3-heptyloxythiophene), poly(3-octyloxythiophene), poly(3-decyloxythiophene), poly(3-dodecyloxythiophene), poly(3-octadecyloxythiophene), poly(3,4-dihydroxythiophene), poly(3,4-dimethoxythiophene), poly(3,4-ethylenedioxythiophene), poly(3,4-propylenedioxythiophene), poly(3,4-butenedioxythiophene), poly(3-carboxythiophene), poly(3-methyl-4-carboxythiophene), poly(3-methyl-4-carboxyethylthiophene), poly(3-methyl-4-carboxybutylthiophene), polyaniline, poly(2-methylaniline), poly(3-isobutylaniline), poly(2-aniline sulfonate), poly(3-aniline sulfonate), and the like.

Co-polymers composed at least two different copolymerized monomers are contemplated. Co-polymers comprise at least one polymerized monomer selected from the group consisting of polypyrrole, polythiophene, poly(4-(2,3-dihydrothieno-[3,4-b][1,4]dioxin-2-yl)methoxy)-1-butane-sulphonic acid, salt), poly(4-(2,3-dihydrothieno-[3,4-b][1,4]dioxin-2-yl)methoxy)-1-methyl-1-propane-sulphonic acid, salt), poly(N-methylpyrrole), poly(3-methylthiophene), poly(3-methoxythiophene), and poly(3,4-ethylenedioxythiophene).

A particularly preferred conductive polymer is poly-3,4-polyethylene dioxythiophene (PEDOT).

The conductive polymer layer can be formed on the dielectric by any technique commonly employed in the art. The conductive polymer can be formed into a slurry and deposited onto the surface. Alternatively, the conductive polymer can be added as monomer and polymerized in-situ as well known in the art.

It is known in the art to additional layers to the cathode to facilitate soldering of the cathode to a lead frame or circuitry. Carbon containing layers and metal containing layers are well known and well documented in the art and further discussion is not warranted herein.

Organofunctional silanes and organic compounds with more than one crosslinking group, especially more than one epoxy group, are particularly suitable for use in combination with the inventive formation electrolyte. The formation electrolyte may include the organofunctional silanes and organic compounds with more than one crosslinking group as additive in combination with inositol derivative. After formation of the dielectric oxide the anode with dielectric thereon can be washed. In an embodiment the anode with dielectric thereon is not washed which allows residual organofunctional silanes and organic compounds with more than one crosslinking group together with inositol derivative to be present during formation of the cathode.

An exemplary organofunctional silane is defined by the formula:

XR₁Si(R₃)₃₋ₙ(R₂)ₙ
wherein X is an organic functional group such as amino, epoxy, anhydride, hydroxy, mercapto, sulfonate, carboxylate, phosphonate, halogen, vinyl, methacryloxy, ester, alkyl etc; R₁ is an aryl or alkyl (CH₂)ₘ wherein m can be 0 to 14; R₂ is individually a hydrolysable functional group such as alkoxy, acyloxy, halogen, amine or their hydrolyzed product; R₃ is individually an alkyl functional group of 1-6 carbon atoms; n is 1 to 3.

The organofunctional silane can also be dipodal, define by the formula:

Y(Si(R³)₃₋ₙ(R²)ₙ)₂
wherein Y is any organic moiety that contains reactive or nonreactive functional groups, such as alkyl, aryl, sulfide or melamine; R₃, R₂ and n are defined above. The organofunctional silane can also be multi-functional or polymeric silanes, such as silane modified polybutadiene, or silane modified polyamine, etc.

Examples of organofunctional silane include 3-glycidoxypropyltrimethoxysilane, 3-aminopropytriethoxysilane, aminopropylsilanetriol, (triethoxysilyl)propylsuccinic anhydride, 3-mercaptopropyltrimethoxysilane, vinyltrimethoxysilane, 3-methacryloxypropyltrimethoxysilane, 3-trihydroxysilyl-1-propane sulfonic acid, octyltriethyoxysilane, bis(triethoxysilyl)octane, etc. The examples are used to illustrate the invention and should not be regarded as conclusive Examples of organofunctional silane include 3-glycidoxypropyltrimethoxysilane, 3-aminopropytriethoxysilane, aminopropylsilanetriol, (triethoxysilyl)propylsuccinic anhydride, 3-mercaptopropyltrimethoxysilane, vinyltrimethoxysilane, 3-methacryloxypropyltrimethoxysilane, 3-trihydroxysilyl-1-propane sulfonic acid, octyltriethyoxysilane, bis(triethoxysilyl)octane, etc. The examples are used to illustrate the invention and should not be regarded as conclusive.

A particularly preferred organofunctional silane is glycidyl silane defined by the formula:

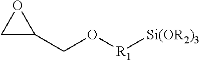

wherein R₁ is an alkyl of 1 to 14 carbon atoms and more preferably selected from methyl ethyl and propyl; and each R₂ is independently an alkyl or substituted alkyl of 1 to 6 carbon atoms.

A particularly preferred glycidyl silane is 3-glycidoxypropyltrimethoxysilane defined by the formula:

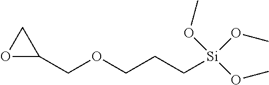

which is referred to herein as “Silane A” for convenience.

A particularly suitable organometallic is neoalkoxy titanate with titanium IV 2,2(bis 2-propenolatomethyl)butanolato, tris neodecanoato-O; titanium IV 2,2(bis 2-propenolatomethyl)butanolato, iris(dodecyl)benzenesulfonato-O; titanium IV 2,2(bis 2-propenolatomethyl)butanolato, tris(dioctyl)phosphato-O; titanium IV 2,2(bis 2-propenolatomethyl)tris(dioctyl)pyrophosphatobutanolato-O; titanium IV 2,2(bis 2-propenolatomethyl)butanolato, tris(2-ethylenediamino)ethylato; and titanium IV 2,2(bis 2-propenolatomethyl)butanolato, tris(3-amino)phenylato being representative neoalkoxy titanates and derivatives thereof.

A crosslinker with at least two epoxy groups is referred to herein as an epoxy crosslinking compound and is defined by the formula:

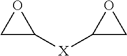

wherein the X is an alkyl or substituted alkyl of 0-14 carbon atoms, preferably 0-6 carbon atoms; an aryl or substituted aryl, an ethylene ether or substituted ethylene ether, polyethylene ether or substituted polyethylene ether with 2-20 ethylene ether groups or combinations thereof. A particularly preferred substitute is an epoxy group.

Examples of epoxy crosslinking compounds having more than one epoxy groups include ethylene glycol diglycidyl ether (EGDGE), propylene glycol diglycidyl ether (PGDGE), 1,4-butanediol diglycidyl ether (BDDGE), pentylene glycol diglycidyl ether, hexylene glycol diglycidyl ether, cyclohexane dimethanol diglycidyl ether, resorcinol glycidyl ether, glycerol diglycidyl ether (GDGE), glycerol polyglycidyl ethers, diglycerol polyglycidyl ethers, trimethylolpropane polyglycidyl ethers, sorbitol diglycidyl ether (Sorbitol-DGE), sorbitol polyglycidyl ethers, polyethylene glycol diglycidyl ether (PEGDGE), polypropylene glycol diglycidyl ether, polytetramethylene glycol diglycidyl ether, di(2,3-epoxypropyl)ether, 1,3-butadiene diepoxide, 1,5-hexadiene diepoxide, 1,2,7,8-diepoxyoctane, 1,2,5,6-diepoxycyclooctane, 4-vinyl cyclohexene diepoxide, bisphenol A diglycidyl ether, maleimide-epoxy compounds, etc.

### EXAMPLES

Wet capacitance and leakage are measured by an LCR meter in 25 wt % Phosphoric acid in water under a test frequency of 120 Hz and test voltage of 70% of formation voltage. For wet leakage, the parts have been tested after a charge time of 120 seconds and DC bias voltage of 2V. ACC (anomalous charging current) is measured at the end of the production process. The finished parts are mounted on a circuit board and measurement is done at 0° C. and 80% Vr and expressed as times theoretical value (xTLV).

Comparative Example: Tantalum anodes (330 microfarads, 16V rated voltage) are prepared by sintering of tantalum powder. First, the anodes are anodized in an electrolyte that works as a control {phosphoric acid about (2-5 wt %), ethylene glycol (50-70 wt %) and water having resistivity of about (100-370) ohm-cm measured at 80° C.} at 35V and 80° C. to form a dielectric oxide on the tantalum anode (1^{st} anodization). The anodes are rinsed, heat-treated at 450° C. for 30 minutes and re-anodized in the original electrolytes. Wet leakage after 1^{st} anodization is given in Table 1. The anodes are then covered in conductive polymer that served as cathode, followed by carbon and silver coatings. Parts get assembled and molded into surface mount finished capacitors using known techniques. ACC is measured at 0° C. on mount parts and reported as current in mA at 12.8V {80% of the rated voltage (Vr)}. Cap and ESR (equivalent series resistance) of the finished part are also reported along with ACC in Table 1.

Inventive Example 1: A series of solid electrolytic capacitors have been prepared in a similar manner to that in comparative example 1 using 300 microfarad parts with rated voltage 16V except that the electrolyte is (5-10 wt %) inositol-6-phosphate in water having resistivity (7-15) ohm-cm at 80° C. Wet leakage after 1^{st} anodization, cap and ESR of finished part are also reported along with ACC as current (mA) at 12.8V (80% of Vr) are given in Table 1.

Inventive Example 2: A series of solid electrolytic capacitors are prepared in similar manner to that in inventive example 1 using 300 microfarad parts with rated voltage 16V except that the anodization electrolyte is a mixture of (5-10 wt %) inositol-6-phosphate and epoxy silane (1:1) in water having resistivity (9-17) ohm-cm at 80° C. Wet leakage after 1^{st} anodization, cap and ESR of finished part are also reported along with ACC as current (mA) at 12.8V (80% of Vr) are given in Table 1.

Inventive Example 3: In this example, a series of solid electrolytic capacitors are prepared in similar manner to that in inventive example 1 using 300 microfarad parts with rated voltage 16V except that the electrolyte has ethylene glycol (EG) added to it. Inositol-6-phosphate (5-10 wt %) is added to ethylene glycol (50-70 wt %) in water having resistivity (75-100) ohm-cm at 80° C. Wet leakage after 1^{st} anodization, cap and ESR of finished part are also reported along with ACC as current (mA) at 12.8V (80% of Vr) are given in Table 1.

Inventive Example 4: In this example, a series of solid electrolytic capacitors are prepared in similar manner using 300 microfarad parts with rated voltage 16V to that in inventive example 2 except that the polymer also has the same electrolyte used in inventive example 2 along with conductive polymer. Wet leakage after 1^{st} anodization, cap and ESR of finished part are also reported along with ACC as current (mA) at 12.8V (80% of Vr) are given in Table 1.

Inventive Example 5: In this example, a series of solid electrolytic capacitors using 300 microfarad parts with rated voltage 16V are prepared in similar manner to that in inventive example 1 except that the electrolyte has inositol (1-6 wt %) and phosphoric acid (1-6 wt %) in water having resistivity of about (10-30) ohm-cm. Wet leakage after 1^{st} anodization, cap and ESR of finished part are also reported along with ACC as current (mA) at 12.8V (80% of Vr) are given in Table 1.

TABLE 1

| | | | Equivalent | |
|---|---|---|---|---|
| | Wet leakage | | Series | Current(mA) at |
| | (nano | Capacitance | resistance | compliance |
| Example | amperes/CV) | (microfarad) | (ohms) | voltage (12.8 V) |
| Comparative | 1.5 | 310 | 0.0274 | 496 |
| Example | | | | |
| Inventive | 0.5 | 288 | 0.0281 | 55 |
| Example 1 | | | | |
| Inventive | 0.6 | 296 | 0.0282 | 58 |
| Example 2 | | | | |
| Inventive | 1.07 | 288 | 0.0292 | 93.5 |
| Example 3 | | | | |
| Inventive | 0.6 | 306 | 0.0315 | 42.9 |
| Example 4 | | | | |
| Inventive | 0.5 | 290 | 0.033 | 244 |
| Example 5 | | | | |

The inventive examples demonstrated the ability to form a capacitor, using the inventive formation electrolyte, having an anomalous charge current less than 4 times the theoretical value. This is otherwise not available in the art.

The invention has been described with reference to preferred embodiments without limit thereto. One of skill in the art would realize additional embodiments which are described and set forth in the claims appended hereto.

What is claimed is:

1. A method of forming a solid electrolytic capacitor comprising:
forming a dielectric oxide on a tantalum anode by:
applying a formation electrolyte on said tantalum anode wherein said formation electrolyte comprises a derivative of inositol is defined by Formula 1: 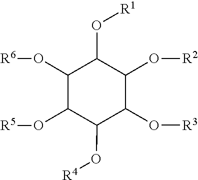
wherein:
each of R¹-R⁶ is independently selected from H, substituted or unsubstituted carbon chain of up to 20 carbon atoms, —PO₃R⁷R⁸; —SiR⁹₃, —C(O)R¹⁰; and 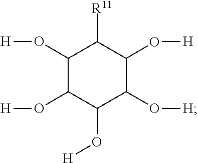
or adjacent groups may be taken together to represent —P(O)OH—O—P(O)OH—;
each R⁷ and R⁸ are independently selected from H, a cation; saturated or unsaturated carbon chain of up 35 carbon atoms; or —CH₂CHR¹²CH₂R¹³;
each R⁹ is independently an alkyl of 1 to 10 carbon atoms;
each R¹⁰ is independently an alkyl of 1 to 10 carbon atoms;
each R¹¹ represents a bond to an oxygen of the derivative of inositol of Formula 1; and
R¹² and R¹³ are esters terminated with H, saturated or unsaturated carbon chain of 1 to 35 carbon atoms; and
forming a conductive polymer cathode on said dielectric oxide.

2. The method of forming a solid electrolytic capacitor of claim 1 wherein at least one of R¹-R⁶ is —PO₃R⁷R⁸ with at least one of R⁷ or R⁸ being —H.

3. The method of forming a solid electrolytic capacitor of claim 2 wherein R⁷ and R⁸ are both —H.

4. The method of forming a solid electrolytic capacitor of claim 2 wherein at least two of R¹-R⁶ is —PO₃R⁷R⁸.

5. The method of forming a solid electrolytic capacitor of claim 4 wherein at least three of R¹-R⁶ is —PO₃R⁷R⁸.

6. The method of forming a solid electrolytic capacitor of claim 4 wherein at least four of R¹-R⁶ is —PO₃R⁷R⁸.

7. The method of forming a solid electrolytic capacitor of claim 6 wherein at least five of R¹-R⁶ is —PO₃R⁷R⁸.

8. The method of forming a solid electrolytic capacitor of claim 6 wherein each of R¹-R⁶ is —PO₃R⁷R⁸.

9. The method of forming a solid electrolytic capacitor of claim 8 with each R⁷ and R⁸ is —H.

10. The method of forming a solid electrolytic capacitor of claim 1 wherein at least one R⁷ or R⁸ is a cation.

11. The method of forming a solid electrolytic capacitor of claim 1 wherein said cation is selected from the group consisting of quaternary amines and saturated or unsaturated carbon chain of up 35 carbon atoms.

12. The method of forming a solid electrolytic capacitor of claim 1 wherein each R⁹ is independently an alkyl of 1 to 3 carbon atoms.

13. The method of forming a solid electrolytic capacitor of claim 12 wherein each R⁹ is —CH₃.

14. The method of forming a solid electrolytic capacitor of claim 1 wherein each R¹⁰ is independently an alkyl of 1 to 3 carbon atoms.

15. The method of forming a solid electrolytic capacitor of claim 14 wherein each R¹⁰ is —CH₃.

16. The method of forming a solid electrolytic capacitor of claim 1 wherein said derivative of inositol is selected from the group consisting of myo-inositol and it's isomers and their respective derivatives namely myo-inositol hexakis phosphate (phytic acid); pentakis-, tri-, di-phosphates and their isomers; and myo-inositol mono phosphate, myo-inositol trispyrophosphate, 1-phosphatidyl-myo-inositol 1-phosphatidyl-myo-inositol 3-phosphate, derivatives of ononitol, sequoytol, dombonitol, viscumitol, pinitol, quebrachitol, pinpollitol and brahol, myo-inositol 1,3,4,5,6-pentakis-O-(trimethylsilyl)-, bis(trimethylsilyl) phosphate, phosphatidylinositol 5-phosphate PI(5) diC8 ammonium salt, phosphatidylinositol 5-phosphate diC16 (PI(5)P diC16) sodium salt, 1,2-ciacyl-sn-glycero-3-phospho-(1-D-myo-inositol 4,5-biphosphate), phosphatidylinositol, phosphatidylinositol 3-phosphate, phosphatidylinositol 4-phosphate, phosphatidylinositol 4,5-phosphate, di-myo-inositol-phosphate, ciceritol phosphate, fagopyritol phosphate, glycosylinositol phosphryl ceramide, C25,25-Archeditylinositol, ceramide phosphoinositol, D-myo-inositol-4-hydrogen phosphate monoammonium salt and phosphatidylinositol phosphate.

17. The method of forming a solid electrolytic capacitor of claim 1 wherein said formation electrolyte comprises additives selected from metal salts, salts of organic acids, salts of inorganic acids, organic acids, inorganic acids, organometallic compounds, inorganic solvents, organic solvents, crosslinking agents, surface active agents and buffers.

18. The method of forming a solid electrolytic capacitor of claim 17 wherein said metal salts, salts of inorganic acids and salts of organic acids comprise halides, nitrides, sulfides, amides, nitrates, sulfates, phosphates, carbonates, chromates, chlorates, perchlorates, oxides, oxychlorides, peroxides, carboxylates, amides and esters.

19. The method of forming a solid electrolytic capacitor of claim 17 wherein said salts of organic acids and salts of inorganic acids comprise carboxylic acids, phosphonic acids, phosphinic acids, phosphoric acid, phthalic acid, maleic acid, malonic acid and trimesic acid.

20. The method of forming a solid electrolytic capacitor of claim 17 wherein said organometallic compounds comprise organosilanes, organoboranes, carbonyls, phosphines, crosslinking agents, surface active agents and buffers.

21. The method of forming a solid electrolytic capacitor of claim 1 wherein said formation electrolyte further comprises at least one solvent selected from the group consisting of water, alcohol, ethylene glycol, polyethylene glycol, tetraglyme, propylene glycol, glycol ether and alkanolamines.

22. The method of forming a solid electrolytic capacitor of claim 1 wherein said conductive polymer cathode is selected from the group consisting of poly(3,4-ethylenedioxythiophene), poly(4-(2,3-dihydrothieno-[3,4-b][1,4]dioxin-2-yl)methoxy)-1-butane-sulphonic acid, salt), poly(4-(2,3-dihydrothieno-[3,4-b][1,4]dioxin-2-yl)methoxy)-1-propane-sulphonic acid, salt), poly(4-(2,3-dihydrothieno-[3,4-b][1,4]dioxin-2-yl)methoxy)-1-methyl-1-propane-sulphonic acid, salt), poly(4-(2,3-dihydrothieno-[3,4-b][1,4]dioxin-2-yl)methoxy alcohol, poly(N-methylpyrrole), poly(3-methylpyrrole), poly(3-octylpyrrole), poly(3-decylpyrrole), poly(3-dodecylpyrrole), poly(3,4-dimethylpyrrole), poly(3,4-dibutylpyrrole), poly(3-carboxypyrrole), poly(3-methyl-4-carboxypyrrole), poly(3-methyl-4-carboxyethylpyrrole), poly(3-methyl-4-carboxybutylpyrrole), poly(3-hydroxypyrrole), poly(3-methoxypyrrole), polythiophene, poly(3-methylthiophene), poly(3-hexylthiophene), poly(3-heptylthiophene), poly(3-octylthiophene), poly(3-decylthiophene), poly(3-dodecylthiophene), poly(3-octadecylthiophene), poly(3-bromothiophene), poly(3,4-dimethylthiophene), poly(3,4-dibutylthiophene), poly(3-hydroxythiophene), poly(3-methoxythiophene), poly(3-ethoxythiophene), poly(3-butoxythiophene), poly(3-hexyloxythiophene), poly(3-heptyloxythiophene), poly(3-octyloxythiophene), poly(3-decyloxythiophene), poly(3-dodecyloxythiophene), poly(3-octadecyloxythiophene), poly(3,4-dihydroxythiophene), poly(3,4-dimethoxythiophene), poly(3,4-ethylenedioxythiophene), poly(3,4-propylenedioxythiophene), poly(3,4-butenedioxythiophene), poly(3-carboxythiophene), poly(3-methyl-4-carboxythiophene), poly(3-methyl-4-carboxyethylthiophene), poly(3-methyl-4-carboxybutylthiophene), polyaniline, poly(2-methylaniline), poly(3-isobutylaniline), poly(2-aniline sulfonate), poly(3-aniline sulfonate)

23. The method of forming a solid electrolytic capacitor of claim 1 wherein said dielectric oxide is not washed prior to said forming of said conductive polymer cathode.

24. The method of forming a solid electrolytic capacitor of claim 1 wherein said dielectric oxide is not washed prior to said forming of said conductive polymer cathode.

25. A capacitor comprising an anode prepared by anodizing a pressed valve metal powder in the formation electrolyte of claim 1.

26. The capacitor of claim 25 wherein said conductive polymer cathode comprises an internal polymer layer and an external polymer layer and said internal polymer layer and said external polymer layer each comprise a pre-polymerized conductive polymer.

27. A capacitor of claim 25 having an anomalous charge current less than 4 times a theoretical value.
